(19) United States
(12) Patent Application Publication
(10) Pub. No.: US 2010/0248861 A1
(43) Pub. Date: Sep. 30, 2010

(54) GOLF BALL-FORMING COMPOSITION, GOLF BALLS PREPARED FROM THE COMPOSITION AND THE PROCESS FOR PREPARING THEREOF

(76) Inventor: Xiongxum Mo, Guangdong (CN)

Correspondence Address: Mo Xiongxun;c/o YH Chan, 42 Pin Oaks Drive, Pheonixville, PA, 19460, US

(21) Appl. No.: 12/734,386

(22) PCT Filed: Sep. 22, 2008
(86) PCT No.: PCT/CN2008/072446

§ 371 Date: Jun. 8, 2010

(30) Foreign Application Priority Data
Sep. 30, 2007 (CN) 200710175551.1

(51) Int. Cl. A63B 37/02; C08L 29/04; B29C 49/04

(52) U.S. Cl. 473/351; 524/557; 264/500

(57) ABSTRACT

A golf ball-forming composition, golf balls prepared from the composition and the process for preparing thereof. The golf ball-forming composition is composed of the following: polyvinyl alcohol resin 5-80 wt %; filler 0-90 wt %, natural high polymer material 0-60 wt %, and plasticizer 5-50 wt %. The filler is the common filler known by the skilled person in the art; the natural high polymer material is celluloses or amyloses; the plasticizer is the common substances used by the skilled person in the art. The golf ball-forming composition is water soluble and biodegradable. The water soluble and biodegradable golf ball has a hollow inside, and has a surface which is disposed with at least one through hole communicated with the hollow. When the golf ball is hit into water, water will enter the hollow via the through hole, thereby increases the contact area between water and the ball and accelerates the dissolution of the ball, so that the ball may eventually completely biodegraded in the environment.

### BACKGROUND OF THE INVENTION

The present invention relates to a golf ball-forming composition, golf balls prepared from the composition and the process for preparing thereof.

Golf is a popular sport well-received by sports lovers around the world. Generally, a golf course is built on land, but water golf is increasingly popular nowadays. Water golf is usually played on yachts, sea shores, rafts, beaches or watersides where players hit the golf balls into the water to experience the joy and excitement of swinging their golf clubs in water environment. Since the golf balls of this kind of water golf are hit directly into the water, it is hard to collect the balls back. Common golf balls made of traditional materials which are not water-soluble and not naturally degradable (such as rubber and synthetic resin) causes white pollution in oceans, rivers, lakes and so forth when they are hit into the water. Since these common golf balls are not completely degradable in natural environment, they are also harmful to oceans, rivers, lakes and other natural environments as well as the living organisms therein. Therefore, common golf balls are not suitable for this kind of water golf.

U.S. Pat. No. 5,098,104 discloses a water-soluble golf ball comprising an outer skin and an inner core. The outer skin is prepared by compression molding or static casting of a mixture formed by first grinding paper pulp, sawdust, lint, straw, thread, twine, leaves and so forth and then adding therein a set proportion of water-soluble polymer (e.g. gelatin, agar, processed seaweed, non-toxic white glue and so forth). The inner core is prepared by using a die to heat and compress a mixture formed by first blending sodium bicarbonate, sodium citrate, sodium chloride, diatomaceous earth or other water-soluble materials to form a base slurry and then adding therein a set proportion of water-soluble polymer. The outer skin and the inner core obtained are then formed into one complete golf ball using a jig or other methods. The patent also discloses that the inner core can be added with materials such as low carbon steel buck shot or fine steel filings. The golf ball disclosed in the patent has a double-layer structure combined by water-soluble adhesive; it can be easily cracked and smashed when it is in use. Its production method and its structure are also relatively complicated.

U.S. Pat. No. 5,356,149 discloses a water-soluble golf ball prepared by injection molding of a mixture comprising environmentally safe thermo setting adhesives or fillers and water-soluble thermo setting adhesive. The patent is an improvement made by the patent owner of the aforementioned patent over the prior patent. In the patent, the water-soluble fillers take the forms of paper pulp, sawdust, lint, straw, thread, twine, leaves and so forth whereas the water-soluble adhesives take the forms of polymers, gelatin, glucose, fructose, animal glue, glycerine, agar, guargum, other similar water-soluble thermo setting adhesives and so forth. According to the patent, the water-soluble fillers are first grounded and then added with water-soluble thermo setting adhesives; the fillers and the adhesives will then be combined by heat and compression and after that, the resulting slurry mixture will be injected into a die to form a solid water-soluble golf ball.

Solubility, especially the solubility in cold water, of the water-soluble adhesives selected for preparing the golf balls disclosed in the aforementioned two patents is not good enough in that the components thereof are deficient in quick water solubility although they have good degradability. Furthermore, as the golf balls are solid in structure, they are dissolved relatively slower in water and more time is required for them to dissolve. In addition, the method for preparing the golf balls disclosed in the aforementioned two patents are both restricted by the characteristics of their respective components. Both methods mix the fillers and the adhesives to form a slurry mixture and then cast the slurry mixture or solidify the slurry mixture in a die to form a solid water-soluble golf ball. However, production in this way is inefficient and inconvenient for large scale industrialized production.

### BRIEF SUMMARY OF THE INVENTION

The first object of the present invention is to provide a golf ball-forming composition that has very good water solubility; the second object of the present invention is to provide a water-soluble biodegradable golf ball prepared from the golf ball-forming composition; the third object of the present invention is to provide a method for preparing the water-soluble biodegradable golf ball.

The first object of the present invention is attained by providing a golf ball-forming composition which comprises:

| | |
|---|---|
| Polyvinyl alcohol resin | 5-80 wt. % |
| Filler | 0-90 wt. % |
| Natural high polymer material | 0-60 wt. % |
| Plasticizer | 5-50 wt. % |

The filler is selected from common fillers known by the skilled person in the art; the natural high polymer material is selected from celluloses or amyloses; the plasticizer is also selected from common substances used by the skilled person in the art. The components of the golf ball-forming composition are selected from materials of good water solubility and so the golf ball-forming composition has good water solubility.

Further, the filler of the golf ball-forming composition is any one or a mixture of a plurality of the following: polyethylene wax, silica, talc, kaolin, clay, bentonite, mica powder, zinc sulfide, barium carbonate, calcium sulfate, barium sulfate, calcium carbonate, magnesium carbonate, magnesium hydroxide, microcrystalline kaolinite, sodium sulfate, potassium sulfate, zinc sulfate, magnesium sulfate, sodium nitrate, potassium nitrate, aluminum nitrate, ammonium chloride, sodium chloride, potassium chloride, magnesium chloride, calcium chloride, calcium stearate, titanium dioxide, lithopone, stearamide and stearic acid. The natural high polymer material is any one or a mixture of a plurality of the following: cellulose, lignin, starch, chitin, chitosan and polysaccharides modified material (e.g. amorphophallus konjac). The plasticizer is any one or a mixture of a plurality of the following: glycerol, double-glycerol, polyethylene glycol, polypropylene glycol, trimethylolpropane, water and sorbitol. The polyvinyl alcohol resin is any one or a mixture of a plurality of polyvinyl alcohol resins of alcoholysis degree from 70 mol % to 89 mol %; preferably, the polyvinyl alcohol resin is any one or a mixture of a plurality of polyvinyl alcohol resins of alcoholysis degree from 80 mol % to 89 mol %. The polyvinyl alcohol resin is any one or a mixture of a plurality of polyvinyl alcohol resins of polymerization degree from 300 to 3000.

And further, the golf ball-forming composition preferably has a content of the polyvinyl alcohol resin of 15-50 wt. %, a content of the filler of 30-75 wt. %, a content of the natural high polymer material of 0-30 wt. % and a content of the plasticizer of 15-40 wt. %.

The second object of the present invention is attained by providing a golf ball prepared from the golf ball-forming composition, wherein the ball is provided with a hollow inside, and the ball has a surface which is disposed with at least one through hole communicated with the hollow. The golf ball of the present invention is different from the water-soluble golf balls mentioned earlier in that the major component of the golf ball-forming composition of the golf ball of the present invention is polyvinyl alcohol resin (PVA resin) which has good water solubility and biodegradability. The mixing ratio of the golf ball-forming composition can also be adjusted according to the required strength, hardness and weight of the golf ball. The selection and content of the filler and additives can be determined by an integrated consideration of the costs of preparation and the ensured performance of the golf ball. That is, increasing the filler can lower the costs of preparing the golf ball of the present invention and can also adjust the strength, hardness and weight of the golf ball. If the content of the filler is too high, preparation of the golf ball will be more difficult, and the speed of the golf ball to dissolve in water will also decrease. Increasing the natural high polymer material not only serves as the filler and reduces the costs of preparing the golf ball, but also increases the speed of the golf ball to be naturally biodegraded. If the content of the natural high polymer material is too high, preparation of the golf ball will be more difficult, the strength and hardness of the golf ball will decrease and the ball will be easily cracked and smashed. If the content of the plasticizer is too high, the plasticizer is likely to exude gradually onto the surface of the golf ball as time passes. The golf ball of the present invention can be the same as a common golf ball in outer appearance with dimples formed over its surface. While the performance of the golf ball of the present invention is maintained as best as possible to be basically the same as a common golf ball during actual use, better water solubility of the ball can be attained by the provision of the through hole on the surface of the ball, so that water can enter the hollow of the ball and thereby increasing the contact area between water and the ball; as a result, both the inside and the outside of the ball can be dissolved, thereby increasing the dissolving speed of the ball.

And further, the ball is 40-60 g in weight and 43-46 mm in diameter. The size of the hollow inside the ball may vary but the minimum wall thickness of the ball should not be less than 3 mm. Also, the surface of the ball is disposed with at least one through hole communicated with the hollow. The diameter of the through hole may be 1-4 mm. With a view to attain quick water solubility, the number of through holes can be more than 1 (e.g. more than 1 through holes arranged in parallel).

The golf ball of the present invention is integrally formed with relatively high strength and hardness, so that the ball will not be smashed easily when it is hit. The major component of the golf ball is water-soluble polyvinyl alcohol, which has good water solubility and is completely biodegradable in natural environment and therefore will not cause white pollution in oceans, rivers and lakes and will not harm the natural environment. Besides, the materials for preparing the golf ball of the present invention are non-toxic and non-polluting and therefore will not harm the living organisms and plants in oceans, rivers and lakes as well. In particular, the golf ball may have a hollow structure so that water can enter the ball through the through hole disposed on the surface of the ball when the ball is hit into water; as a result, the contact area between water and the ball will increase and dissolution of the ball in water will thereby be accelerated.

The third object of the present invention is attained by providing a process for preparing a golf ball which comprises mixing the components first and then extruding and blow molding the mixture, the steps of which are as follows:

Step 1: Mixing the components to obtain a mixture;

Step 2: Mixing and refining the mixture obtained in Step 1 to obtain a refined mixture;

Step 3: Adding the mixture obtained in Step 1 or the refined mixture obtained in Step 2 to an extruder for plastics extrusion to obtain a parison;

Step 4: Blow molding the parison obtained in Step 3 is form a ball.

The preparation process is simple, the production costs are low, and it complies with environmental requirements. The process for preparing the golf ball of the present invention is simple and practical and it is suitable for large scale industrialized production.

Further, the mixing in Step 1 is conducted at a controlled temperature of below 100° C. for 15-90 minutes. The mixing and refining in Step 2 is conducted at a controlled temperature of below 100° C. for 10-90 minutes. The mixture or the refined mixture is fed to a single screw extruder or a twin-screw extruder for extrusion and a pipe mould is used to form the extrudant to a hollow tubular parison. In Step 4, the hollow tubular parison is blow molded to form a ball with a hollow inside. The temperature intervals from the inlet of the extruder to the mold at the outlet are in the order of 50-100° C., 90-150° C., 90-180° C., 90-180° C., 90-180° C. and 50-150° C.

According to the process for preparing the golf ball of the present invention, it is also possible to prepare a solid water-soluble and biodegradable golf ball by injection molding of the mixture obtained in Step 1 or the refined mixture obtained in Step 2.

In summary of the above, the present invention provides a golf ball-forming composition with good water solubility. The golf balls prepared by the composition has the following characteristics: 1) The ball can be dissolved in water more quickly, and there is no insoluble impurities which harms the environment, therefore it would not cause white pollution in oceans, rivers and lakes; 2) The ball is capable of completely degraded in the natural environment and therefore would not harm oceans, rivers and lakes; 3) All components are non-toxic and non-polluting and therefore would not harm the living organisms in oceans, rivers and lakes; 4) The ball is suitable for golf sport in terms of strength, hardness and elasticity; 5) The ball may have a hollow structure with a through hole disposed on its surface and communicated with the hollow inside the ball, thereby accelerating the dissolving and degrading speed of the ball; 6) The process for preparing the golf ball of the present invention is simple and practical and is suitable for large scale industrialized production.

### BRIEF DESCRIPTION OF THE DRAWINGS

FIG. 1 shows the outer appearance of the solid golf ball of the present invention.

FIG. 2 shows the outer appearance of the hollow golf ball of the present invention, the surface of which is disposed with a through hole 1b.

FIG. 3 is a cross-sectional view along line A-A in FIG. 2.

In the drawings, the reference characters are detailed as follows:

10: ball; 1a: hollow; 1b: through hole

### DETAILED DESCRIPTION OF THE INVENTION

The object of the present invention is to achieve good water solubility of the material by adjusting the mixing ratio of the golf ball-forming composition. Moreover, a golf ball prepared by the golf ball-forming composition material can attain better contact with water by means of the through holes communicated with the hollow. The golf ball has good water solubility and is completely degradable in natural environment and so it does not pollute or harm any water environment. Furthermore, the performance of the golf ball is close to a common golf ball during actual use and it is particularly suitable for water golf played in golf courses on yachts, sea shores, lakesides, riversides and so forth. The present invention will be further described with reference to the embodiments, but the embodiments should not be regarded as limiting. The selection and content of the components of the composition, and the temperature and time of the preparation process may vary according to different needs yet still produce no substantial impact on the end results.

The golf balls in the following embodiments are prepared according to the following steps:

Step 1: Adding a set mixing ratio of polyvinyl alcohol resin, filler, natural high polymer material and plasticizer to a mixer to mix for 15 to 90 minutes under a controlled temperature of below 100° C. to obtain a mixture.

Step 2: Adding the mixture obtained in Step 1 to a twin-roll plastics mixer to mix and refine for 10 to 90 minutes under a controlled temperature below 100° C. to obtain a refined mixture.

Step 3: Adding the mixture obtained in Step 1 or the refined mixture obtained in Step 2 to a single screw extruder or a twin-screw extruder for plastics extrusion to extrude a cylindrical tubular parison via a pipe mould. The temperature intervals from the inlet to the mold at the outlet during the plastics extrusion process are in the order of 50-100° C., 90-150° C., 90-180° C., 90-180° C., 90-180° C. and 50-150° C.

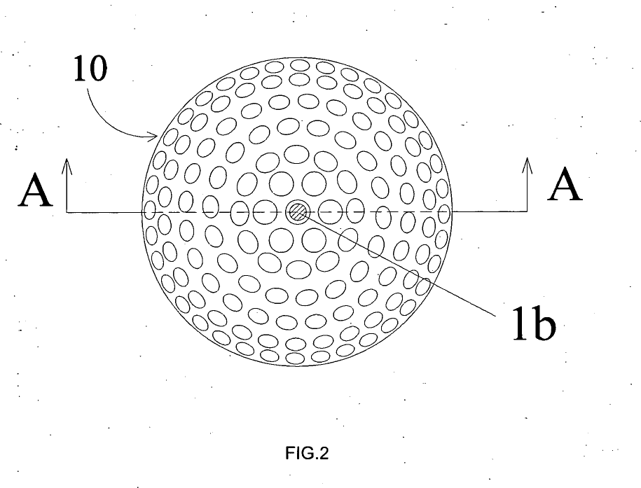

Step 4: The cylindrical tubular parison of certain length obtained in Step 3 is fed to a golf ball mold to form a ball by blow molding. The golf ball prepared is formed with dimples all over its surface, just like a regular golf ball. The surface of the ball 10 is shown in FIG. 2.

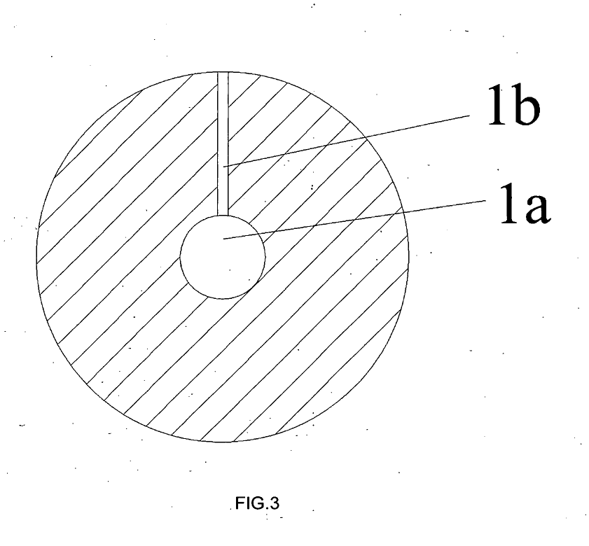

The ball prepared according to the steps above is shown in FIG. 2 and FIG. 3. The surface of the ball 10 can be the same as a common golf ball in outer appearance. Its diameter is d and its surface is disposed with at least one through hole 1b. The ball has a hollow 1a inside and the hollow 1a communicates with the surface of the ball via the through hole 1b. When the ball 10 is hit into water, water gradually enters the hollow 1a via the through hole 1b, thereby increasing the contact area between the water and the ball 10 and thus accelerating the dissolution of the ball 10. FIG. 3 is an illustration of the golf ball provided by the present invention. During the preparation process thereof, the shape or position of the hollow may vary due to differences in the control of the preparation process. Hence, the present invention does not impose strict restriction on the shape and position of the hollow inside the ball. However, the minimum wall thickness of the ball 10 should not be less than 3 mm.

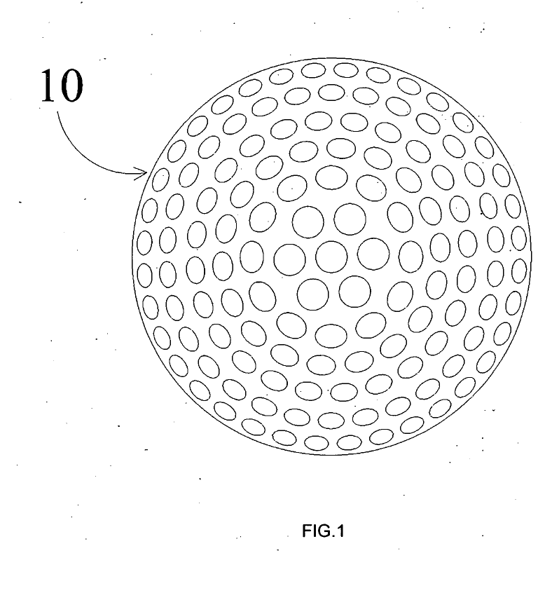

In Step 3, a solid spherical golf ball can be prepared by known injection molding methods by feeding the mixture obtained in Step 1 or the refined mixture obtained in Step 2 to an injection molding machine. The outer appearance of the resulting ball 10 is shown in FIG. 1.

The golf ball-forming composition is described in the following embodiments. The basic proposal of the golf ball-forming composition of the present invention is first described briefly as follows: a golf ball-forming composition having a weight composition of:

| | |
|---|---|
| Polyvinyl alcohol resin | 5-80 wt. % |
| Filler | 0-90 wt. % |
| Natural high polymer material | 0-60 wt. % |
| Plasticizer | 5-50 wt. % |

The filler is selected from common fillers known by the skilled person in the art; the natural high polymer material is selected from celluloses or amyloses; the plasticizer is selected from common substances used by the skilled person in the art.

The polyvinyl alcohol resin used in the following embodiments includes GM-14 (alcoholysis degree from 86.5 mol % to 89.0 mol % and polymerization degree from 1500 to 2000), GL-05 (alcoholysis degree from 86.5 mol % to 89.0 mol % and polymerization degree from 300 to 700) and GH-20 (alcoholysis degree from 86.5 mol % to 89.0 mol % and polymerization degree from 2000 to 2500), all of which belongs to the GOHSENOL series manufactured by a Japanese company NIPPON GOHSEI, and JL-18E (alcoholysis degree from 83.0 mol % to 86.0 mol % and polymerization degree from 1500 to 2000) manufactured by a Japanese company JAPAN VAM & POVAL. The components in all the following embodiments are measured in weight percentage (base value being the total weight of the mixture for preparing the golf ball) and are used for preparing the water-soluble biodegradable golf ball of the present invention according to the above preparation process. The specification of the golf ball of the present invention is basically the same as that of a common golf ball, that is, the ball is 40-60 g in total weight and 43-46 mm in diameter d. If the ball 10 has a hollow structure as shown in FIG. 3, the through hole 1b which is disposed on the surface of the ball and communicated with the hollow is approximately 2 mm in diameter.

### Embodiment 1

Components and mixing ratio: Polyvinyl alcohol resin (GM-14) 18%, barium sulfate 45%, titanium dioxide 2%, glycerine 20% and water 15%.

### Embodiment 2

Components and mixing ratio: Polyvinyl alcohol resin (JL-18E) 24%, starch 10%, magnesium hydroxide 30%, titanium dioxide 1%, barium sulfate 12%, sorbitol 2% and water 21%.

### Embodiment 3

Components and mixing ratio: Polyvinyl alcohol resin (GM-14) 14%, polyvinyl alcohol resin (GL-05) 9%, talcum powder 55%, sorbitol 2% and water 20%.

### Embodiment 4

Components and mixing ratio: Polyvinyl alcohol resin (GM-14) 30%, starch 45%, polyethylene glycol 3% and water 22%.

### Embodiment 5

Components and mixing ratio: Polyvinyl alcohol resin (GH-20) 45%, barium sulfate 30%, polyethylene glycol 4% and water 21%.

Tests on water solubility of the golf ball

In an environment of a temperature of 30° C. and a relative humidity of 65%, water-soluble biodegradable golf balls (with hollow structure) prepared from the above embodiments are placed into flowing water; select 3 of them randomly and observe their changes.

Test Sample 1

Specification of the ball: 44 mm in diameter and 51 g in weight.

Test records:

At 1 hour, the surface of the ball had a layer of white and slurry polyvinyl alcohol and appeared to be softened, indicating that the ball started to dissolve; water could also be seen entering the ball via the through hole;

At 2 hours, more fractures appeared on the outer layer of the ball; small sheets of peel-offs started to appear on the outer layer of the ball; dissolution of the ball in the area around the through hole was obvious; diameter of the through hole was also enlarged;

At 4 hours, the outer layer of the ball was seriously peeled off; dissolution of the surface of the ball was obvious;

At 20 hours, a layer of fluffy material was formed at the outer layer of the ball; the dimple structure on the outer surface of the ball became unclear; softening of the outer layer of the ball became much more obvious; larger fractures appeared on the surface of the ball;

At 40 hours, fractures on the surface of the ball continued to be widened; the outer layer of the ball was dissolved and peeled off; cracks appeared at thin wall of the ball;

At 46 hours, a crack of 6 cm long, 5 mm wide and approximately 1 cm deep ran from the through hole to the joint of the ball; larger sheets of peel-offs appeared at the outer layer of the ball; more water entered the hollow of the ball;

At 60 hours, a crack of approximately 4 cm long and 2 mm wide appeared at the inner side of the ball; the crack on the surface of the ball was widened to 8 mm;

At 72 hours, the crack of the through hole on the surface of the ball was further widened to 1.5 cm; several cracks appeared in the area around the through hole of the ball; the front side of the ball joins the back side of the ball; the ball was finally completely disintegrated.

Test Sample 2

Specification of the ball: 44 mm in diameter and 45 g in weight.

Test records:

At 1 hour, dimples on the surface of the ball were increasingly indistinct; a thin layer of fractures (resembling skin peel) appeared; dissolution of the ball started to take place and texture of the surface of the ball became softer;

At 15 hours, several fractures of approximately 2 cm long appeared on the surface of the ball; the diameter of the through hole of the ball was widened and the ball was slowly and gradually deformed;

At 26 hours, two cracks each of approximately 10 mm long appeared on the surface of the ball; as time passed, there were more and wider cracks on the ball and the ball was obviously deformed;

At 40 hours, small pieces of material started to fall off from the ball; breaking and cracking of the ball were increasingly serious;

At 50 hours, the ball was broken completely into 2 hemispheres; there were more and wider cracks all over other area of the ball and there were gradually more small pieces of material falling off from the ball;

At 72 hours, the ball was broken completely into around 12 small pieces of different sizes; the ball was close to complete disintegration; the broken pieces were also gradually reduced in size.

Test Sample 3

Specification of the ball: 44 mm in diameter and 45 g in weight.

Test records:

At 1 hour, dimples on the surface of the ball were increasingly indistinct; a thin layer of fractures (resembling skin peel) appeared on the surface of the ball; dissolution of the surface of the ball started to take place;

At 10 hours, 2 relatively shallow fractures appeared around the through hole of the ball;

At 24 hours, several fractures appeared on the surface of the ball; the diameter of the through hole of the ball was widened; the ball was deformed; more fractures gradually appeared on the surface of the ball and the fractures became longer and deeper;

At 40 hours, fractures appeared on many parts of the ball; fractures on the ball became longer and deeper; cracks were relatively wider in the area of the through hole and on its contralateral sides and they joins with each other; the ball has already been seriously deformed;

At 45 hours, small pieces of material started to fall off from the ball;

At 60 hours, breaking and cracking of the ball were increasingly serious;

At 72 hours, the ball was broken into 2 halves and there were wider cracks all over other area of the ball.

In conclusion, the golf ball according to the present invention has good water solubility and good natural biodegradability.

1. A golf ball-forming composition which comprises:

| | |
|---|---|
| Polyvinyl alcohol resin | 5-80 wt. % |
| Filler | 0-90 wt. % |
| Natural high polymer material | 0-60 wt. % |
| Plasticizer | 5-50 wt. % |

the polyvinyl alcohol resin is any one or a mixture of a plurality of polyvinyl alcohol resins of alcoholysis degree from 80 mol % to 89 mol % and polymerization degree from 300 to 3000; the filler is selected from common fillers known by the skilled person in the art; the natural high polymer material is selected from celluloses or amyloses; the plasticizer is also selected from common substances used by the skilled person in the art.

2. (canceled)

3. (canceled)

4. (canceled)

5. (canceled)

6. (canceled)

7. (canceled)

8. (canceled)

9. (canceled)

10. A water soluble and biodegradable golf ball prepared by the golf ball-forming composition as in claim 1, characterized in that the ball is provided with a hollow inside, and the ball has a surface which is disposed with at least one through hole communicated with the hollow.

11. The golf ball as in claim 10, characterized in that the ball is 40-60 g in weight and 43-46 mm in diameter.

12. A process for preparing the water soluble and biodegradable golf ball as in claim 10, which comprises mixing components first and then extruding and blow molding the mixture, the steps of which are as follows:
Step 1: Mixing the components to obtain a mixture;
Step 2: Mixing and refining the mixture obtained in Step 1 to obtain a refined mixture;
Step 3: Adding the mixture obtained in Step 1 or the refined mixture obtained in Step 2 to an extruder for plastics extrusion to obtain a parison;
Step 4: Blow molding the parison obtained in Step 3 is form a ball.

13. The preparation process as in claim 12, characterized in that the mixing in Step 1 is conducted at a controlled temperature of below 100° C. for 15-90 minutes.

14. The preparation process as in claim 12, characterized in that the mixing and refining in Step 2 is conducted at a controlled temperature of below 100° C. for 10-90 minutes.

15. The preparation process as in claim 12, characterized in that the mixture or the refined mixture is fed to a single screw extruder or a twin-screw extruder for extrusion and a pipe mould is used to form the extrudant to a hollow tubular parison.

16. The preparation process as in claim 15, characterized in that temperature intervals from the inlet of the extruder to the mold at the outlet are in the order of 50-100° C., 90-150° C., 90-180° C., 90-180° C., 90-180° C. and 50-150° C.

17. The preparation process as in claim 12, characterized in that in Step 4, the hollow tubular parison is blow molded to form a ball with a hollow inside.
